(19) United States
(12) Patent Application Publication
(10) Pub. No.: US 2003/0077110 A1
(43) Pub. Date: Apr. 24, 2003

(54) Flexible joint assembly, service, and system using a flexible joint assembly

(76) Inventor: Steven M. Knowles, Silver Lake, IN (US)

Correspondence Address: FISH & RICHARDSON P.C., 1425 K STREET, N.W., 11TH FLOOR, WASHINGTON, DC, 20005-3500, US

(21) Appl. No.: 09/982,928

(22) Filed: Oct. 22, 2001

(51) Int. Cl. F16C 11/06

(52) U.S. Cl. 403/56

(57) ABSTRACT

A flexible joint assembly includes a joint assembly inlet, a joint assembly outlet, and a fluid flow path between the inlet and the outlet. The fluid flow path includes a first pivot joint, a second pivot joint, and a central fluid conductor fluidly coupling the pivot joints. A method of servicing a fluid system includes transporting a fluid through a service device including the flexible joint assembly.

### TECHNICAL FIELD

This invention relates to the transport of fluids and, more particularly, to flexible joint assemblies, systems including flexible joint assemblies, and the service of fluid systems using flexible joint assemblies.

### BACKGROUND

When successfully transporting fluids using a fluid conduit, the fluid conduit withstands the pressure differential between the interior and the exterior of the conduit at all positions along the length of the conduit. As a result, many such conduits, including the joints between unitary conduits, are made from mechanically robust but relatively stiff, inflexible materials, such as copper and galvanized steel pipes. Indeed, as the pressure differential between the interior and the exterior of a conduit increases, conduits can become increasingly stiff. This relationship between flexibility and mechanical robustness makes it relatively difficult to deliver pressurized fluids to certain locations. For example, if pressurized fluid is to be delivered to a location on a vibrating piece of equipment, to a location that changes as equipment is serviced, or to a physically confined location difficult to access with a service device, then fluid transport can be difficult and/or impossible to achieve.

One example of the transport of a pressurized fluid to such a location is the transport of refrigerant into a climate control system of an automobile from a refrigerant reservoir. Climate control systems can be charged with refrigerants, such as, for example, chlorofluorocarbons, hydrochlorofluorocarbons, or hydrofluorocarbons, and can operate at pressures commonly between 60 and 800 PSI. Because these air conditioning systems are integrated into a vehicle, the location of the service ports to these systems changes depending upon, for example, the vehicle make and model, the position of the vehicle along an assembly line, or the position at which the vehicle is parked. As a result, successive engagement and disengagement with the fittings of automotive air conditioning systems by relatively inflexible conduits is often arduous and time consuming.

### SUMMARY

A flexible, fluid conducting joint assembly can withstand relatively large pressure differentials for the transport of pressurized fluids. Flexible joint assemblies can facilitate transport of pressurized fluids to a variety of locations, to physically confined locations, or to locations that shift with time.

In one aspect, a flexible joint assembly for conducting a fluid includes a joint assembly inlet, a joint assembly outlet, and a fluid flow path between the inlet and the outlet. The fluid flow path includes a first pivot joint, a second pivot joint, and a central fluid conductor fluidly coupling the pivot joints. The pivot joints together provide greater than a 60° bend between the inlet and the outlet.

In another aspect, a flexible joint assembly includes a joint assembly inlet, a joint assembly outlet, and a fluid flow path between the inlet and the outlet. The flow path includes a first pivot joint, a second pivot joint, and a central fluid conductor fluidly coupling the pivot joints. Each of the first pivot joint and second pivot joint includes an inner member, a receiving member dimensioned to pivotally receive at least part of the inner member, a sealing member sealing between the inner member and the receiving member, and a supporting member supporting the sealing member substantially uniformly over the entire length of the seal between the inner member and the receiving member.

In another aspect, a flexible joint assembly includes a joint assembly inlet, a joint assembly outlet, and a fluid flow path between the inlet and the outlet. The fluid flow path includes a first pivot joint configured to pivot about a first pivot P1, a second pivot joint configured to pivot about a second pivot P2, and a central fluid conductor fluidly coupling the first pivot joint and the second pivot joint. Each of the first and second pivot joints include an inner member having a dimension D in a direction substantially normal to a path through the respective of the joint assembly inlet and outlet, a receiving member dimensioned to receive at least part of the inner member, and a sealing member sealing the inner member to the receiving member at a distance of less than 14% of the dimension D from the respective pivot. Each of the first pivot P1 and the second pivot P2 can be a pivot point.

In another aspect, a flexible joint assembly includes a joint assembly inlet, a joint assembly outlet, and a fluid flow path between the inlet and the outlet. The fluid flow path includes a first pivot joint configured to pivot over a first arc about a first pivot P1, a second pivot joint configured to pivot over a second arc about a second pivot P2, and a central fluid conductor fluidly coupling the pivot joints. Each of the first and second pivot joints include a first joint member coupled to the central fluid conductor, and a second joint member coupled to one of the joint assembly inlet and the joint assembly outlet. Either the first joint member is dimensioned to pivotally receive at least part of the second joint member or the second joint member is dimensioned to pivotally receive at least part of the first joint member. The received joint member has a dimension D in a direction substantially normal to a path through the respective of the joint assembly inlet and outlet. A contact point between the receiving joint member and the central fluid conductor whereby the pivot joint is fully pivoted over the respective arc being within 75% of the dimension D distant from the respective pivot.

In another aspect, a flexible joint assembly includes a first ball and socket joint, a second ball and socket joint, and a unitary central fluid conductor connecting the first ball and socket joint and the second ball and socket joint. The assembly is configured to withstand pressures between about 200 and 5000 PSI. Each of the first ball and socket joint and second ball and socket joint can include a sealing member between the ball and the socket and a supporting member contacting the sealing member substantially uniformly over the entire length of the seal between the ball and the socket.

In another aspect, a method of servicing a fluid system includes connecting a service device with a service port of a fluid system and transporting a fluid pressurized to between 200 and 5000 PSI through the service device. The service device includes a flexible joint assembly including a pair of ball and socket joints connected by a fluid conductor. The fluid can be a refrigerant. The flexible joint assembly can be configured to bend through an angle of up to 90°. The fluid can be pressurized above 300 PSI. Each of the ball and socket joints can include a ball having a diameter D and pivoting about a pivot point and a retaining ring retaining the ball in the ball and socket joint. The fluid conductor can include each ball connected by a pipe member. The fluid system can be a climate control system.

In another aspect, a method of servicing a fluid system includes connecting a service device with a service port of the fluid system, the service device including a flexible joint assembly, and transporting a fluid through the coupling. The flexible joint assembly includes a pair of flexible joints connected by a fluid conductor and is configured to bend through an angle greater than 60°. The flexible joint assembly can be configured to bend through an angle greater than 80°. The flexible joint assembly can be configured to bend through an angle greater than 88°. The fluid system can be a climate control system. The fluid can be a refrigerant.

Each pivot joint can independently include a ball and socket joint. Each ball and socket joint can include a socket, a ball received in the socket, and a seal between the ball to the socket. Each ball and socket joint can include a compressing member axially compressing the seal between the ball and the socket. Each compressing member can include a retaining ring compressing the seal between the ball and the socket. The central fluid conductor can couple to a first ball of the first pivot joint and a second ball of the second pivot joint. The first pivot joint and second pivot joint can together provide a substantially 90° bend between the inlet and the outlet. The central fluid conductor can be unitary. The central fluid conductor can be shorter than 10 centimeters. The joint assembly inlet and the joint assembly outlet can include a fitting. Each pivot joint can independently provide greater than a 35° bend in the fluid flow path. Each pivot joint can independently provide greater than a 40° bend in the fluid flow path. Each sealing member can include an annular seal having a first surface. Each supporting member can include an annular support having a second surface configured to mate with the first surface of the annular seal thereby supporting the annular seal substantially uniformly. Each receiving member can include a first engagement surface and each supporting member can include a second engagement surface. The first engagement surface can be configured to engage the second engagement surface to maintain a fixed relative position between the receiving member and the supporting member. The first engagement surfaces can include threads dimensioned to engage with threads on the second engagement surface. Each sealing member can include an elastomeric material. Each inner member can include a ball, each receiving member can include a socket, and each sealing member can include an O-ring sealing the ball to the socket. The O-ring can have an inner diameter greater than 90% of the diameter of the ball. The receiving joint member can extend less than 35% of the dimension D beyond the first pivot joint. Each of the first pivot joint and the second pivot joint can include a second joint member dimensioned to pivotally receive at least part of the first joint member and extend less than 30% of the dimension D centrally beyond the respective pivot. Each of the first pivot P1 and the second pivot P2 can be a pivot point. The first joint member can be dimensioned to receive at least part of the second joint member and define a chamber in communication with the central fluid conductor. The chamber can be dimensioned to subsume an at least 115° arc about the respective pivot. The dimension D can be a diameter of the ball in a ball and socket joint.

Other features, objects, and advantages of the invention will be apparent from the description and drawings, and from the claims.

### DESCRIPTION OF THE DRAWINGS

FIG. 1 is a view of a service system including a flexible joint assembly.

FIG. 2A is a sectional view of a flexible joint assembly in a straight position.

FIG. 2B is a sectional view of a socket of the flexible joint assembly of FIG. 2A.

FIG. 2C is an enlarged sectional view of a portion of the flexible joint assembly of FIG. 2A.

FIG. 3 is a sectional view of a flexible joint assembly in an offset position.

FIG. 4 is a sectional view of a flexible joint assembly in a 90° bend position.

FIG. 5 is a sectional view of a flexible joint assembly in a straight position.

### DETAILED DESCRIPTION

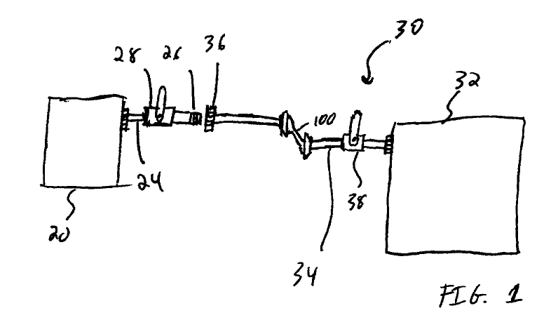

Referring to FIG. 1, a fluid system 20 can be serviced using a service device 30 that includes a flexible joint assembly. The fluid system can be pressurized, for example, having a fluid pressure between 20 and 5000 PSI, particularly between 40 and 4500. The pressure can be greater than 200 PSI, or less than 4000 PSI.

Fluid system 20 includes a valve 28 and a service port 26 on an inlet line 24.

Service device 30 includes a fluid chamber 32 in communication with a line 34. Fluid chamber 32 can be filled, for example, with a pressurized fluid. Line 34 terminates in a coupling 36 and includes both a valve 38 and flexible joint assembly 100 between coupling 36 and chamber 32. Flexible joint assembly 100 provides flexibility to pressure line 34 while allowing operation with a pressurized fluid.

System 20 can be serviced by aligning and engaging coupling 36 with service port 26. The flexibility in line 34 provided by joint assembly 100 facilitates alignment and engagement of service device 30 to service port 26. For example, if service port 26 is often found at different locations or if service port 26 moves, then assembly 100 can flex to accommodate the displacement.

If service device 30 is designed to pressurize system 20, service device 30 can be designed to charge an automotive air conditioning system and line 34 can be used to conduct refrigerant fluid from chamber 32 into system 20 when the pressure in chamber 32 is greater than the desired maximum pressure in system 20. The operator aligns and engages fluid coupling 36 with corresponding service port 26. This includes flexing joint assembly 100 as needed to attach coupling 36 to service port 26. After engagement, the operator can open valves 38 and 28 to allow refrigerant fluid to charge system 20. Once a desired amount of refrigerant fluid has been delivered to system 20, valves 38 and 28 can be closed and coupling 36 can be disengaged from port 26.

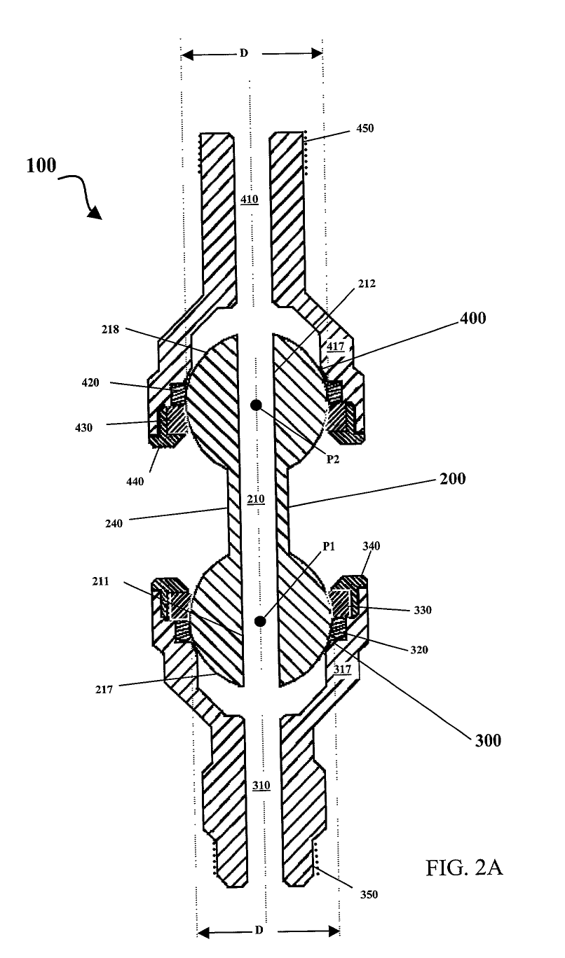

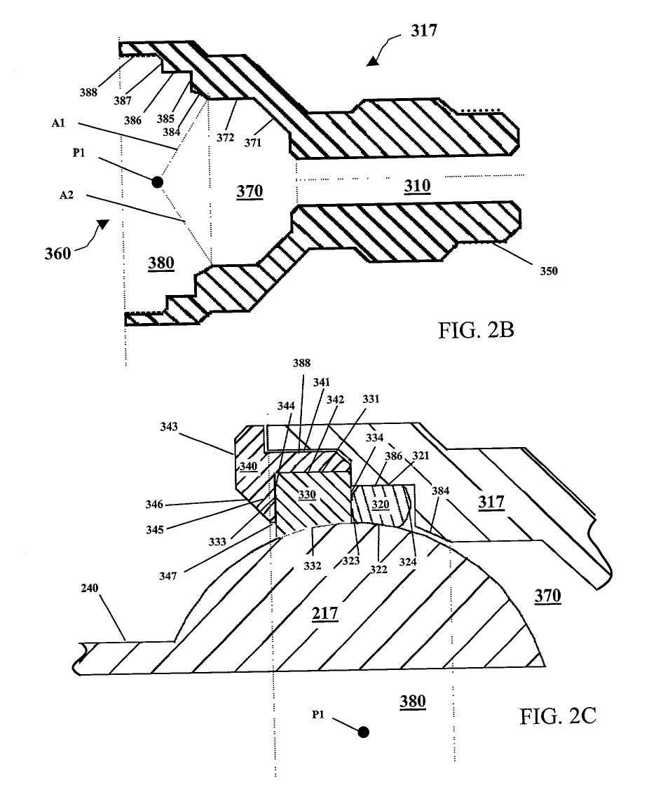

Referring to FIG. 2A, flexible joint assembly 100 includes a fluid conductor 200, a first ball and socket joint 300, and a second ball and socket joint 400. Fluid conductor 200 is of unitary construction and has a tubular central portion 240 that defines a straight longitudinal channel 210 between a first conductor end 211 terminated by a ball 217 and a second conductor end 212 terminated by a ball 218. Channel 210 can be rotationally symmetric about the center of the channel. Balls 217, 218 have diameter D. Balls 217, 218 each form ball and socket joints 300, 400 in conjunction with respective sockets 317, 417, sealing members 320, 420, supporting members 330, 430, and retaining rings 340, 440. Sockets 317, 417 each define respective longitudinal channels 310, 410 that are in fluid communication with longitudinal channel 210 and can be rotationally symmetric about the center of the channel. Longitudinal channels 310, 410 each terminate at a respective fitting 350, 450. First ball and socket joint 300 and second ball and socket joint 400 seal the juncture of channels 310, 410 with channel 210, and allow for swiveling about pivot points P1, P2 at the center of balls 217, 218. Since first ball and socket joint 300 and second ball and socket joint 400 swivel about a respective pivot point P1, P2, the path of fluid flow through flexible joint assembly 100 is flexible and can pass through one or more geometric planes.

For the sake of convenience, the structure of first ball and socket joint 300 and second ball and socket joint 400 will be discussed using the reference numbers associated with first ball and socket joint 300.

Referring to FIG. 2B, channel 310 of socket 317 extends through a fitting 350 to a socket chamber 360. Fitting 350 can be any of a variety of end fittings suitable for connecting with a fluid system 30, including, for example, a ¼ inch or ⅜ inch male flare fitting, a ¼ inch or a ⅜ inch female swivel fitting, a 14 mm male or female fitting, a threaded fitting, a hose barb, a SWAGELOCK fitting, a ½ inch ACME male or female swivel fitting, or a pipe fitting. Socket chamber 360 includes an interior prechamber 370 and an exterior receiving chamber 380. Interior prechamber 370 is defined in part by an angled face 371 and an annular wall 372. Exterior receiving chamber 380 is defined in part by an angled face 384, a lateral face 385, an annular wall 386, a second lateral face 387, and an interiorly threaded annular wall 388. In the portion defined by annular wall 372, prechamber 370 is generally tubular in shape and has a diameter that is slightly smaller than the diameter of ball 217 (not shown). This prevents ball 217 from sealing with angled face 371. Interior prechamber 370 can subtend a greater than 115° conical arc defined by lines A1, A2 between pivot P1 and the junction between annular wall 372 and angled face 384. Interior prechamber 370 can subtend, for example, a 121° conical arc of such a sphere. On the other hand, receiving chamber 380 is dimensioned to receive ball 217, allowing ball 217 to be inserted until it contacts or nearly contacts angled face 384 when the assembly is not pressurized. Angled face 384 and ball 217 do not contact when the assembly is pressurized.

Referring to FIG. 2C, ball 217 is sealed in receiving chamber 380 by sealing member 320, supporting member 330, and retaining ring 340. Sealing member 320 has an outer radial surface 321, an inner radial surface 322, and lateral surfaces 323, 324. Inner radial surface 322 is dimensioned to be at least slightly smaller in diameter than ball 217, but large enough in diameter to seal with ball 217 outside prechamber 370. In other words, sealing member 320 seals with ball 217 close to the pivot point P in receiving chamber 380. It is preferred that the inner diameter of sealing member 320 be greater than 90% of the diameter of ball 217, and more preferred greater than 95% of the diameter of ball 217. Outer radial surface 321 seals with wall 386. The inner diameter of sealing member 320 can be, for example, 98.6% of the diameter of ball 217. The plane containing sealing member 320 can be less than 14% of the diameter of ball 217 away from pivot point P1, and more preferably less than 10%. The plane containing sealing member 320 can be, for example, 8.2% of the diameter of ball 217 away from pivot point P1. Supporting member 330 has an outer radial surface 331, an inner radial surface 332, and lateral surfaces 333, 334. Inner radial surface 332 is dimensioned to be at least slightly smaller in diameter than ball 217 and is contoured to follow the surface of ball 217. The inner diameter of supporting member 330 can be, for example, 93.8% of the diameter of ball 217. Lateral surface 334 of supporting member 330 contacts lateral face 323 of sealing member 320 substantially completely on the circumference of ball 217. Retaining ring 340 has a threaded outer radial surface 341, an inner radial surface 342, lateral surfaces 343, 344 and an inwardly extending pointed lip 345 with an angled face 346. Threaded outer radial surface 341 is dimensioned to threadedly mate with interiorly threaded wall 388. Lateral surface 344 of retaining ring 340 contacts lateral face 333 of supporting member 330 substantially completely on the circumference of ball 217. Angled face 346 and lateral face 333 meet at a vertex 347 that follows an annular path with a diameter at least slightly larger than the diameter of ball 217. Vertex 347 can have, for example, an inner diameter of 100.8% of the diameter of ball 217 to permit assembly. As discussed further below, angled face 346 allows central portion 240 to swivel through an arc within socket 317 by allowing increased angular displacement of central portion 240 without contacting retaining ring 340.

Referring to FIGS. 2B and 2C, when assembling ball and socket joint 300, sealing member 320 is positioned within receiving chamber 380 such that outer surface 321 contacts wall 386 and inner surface 322 extends radially inward beyond lateral wall 385. Retaining ring 340 slips over ball 217 over central portion 240. Supporting member 330, which can be a split ring, is then positioned around central portion 240 and against lateral face 333 of supporting member 330. The user then inserts ball 217 into receiving chamber 380. Supporting member 330 is selected and positioned such that, within receiving chamber 380, lateral surface 334 contacts lateral wall 387 and lateral face 323 of sealing member 320, and inner radial surface 332 contacts ball 217. Supporting member 330 is oriented such that angled inner radial surface 332 has a relatively large contact area with ball 217. The user then threads retaining ring 340 into threaded outer radial surface 341, thereby applying an inward axial force to both sealing member 320 and supporting member 330. This axial force acts to retain ball 217 within receiving chamber 380 between supporting member 330 and angled face 384, as well as to axially compress sealing member 320 between supporting member 330 and wall 385. Moreover, since lateral surface 334 of supporting member 330 contacts with lateral face 323 of sealing member 320 uniformly over a substantially complete circumference, sealing member 320 is substantially uniformly compressed and supported by supporting member 330.

Both the retention of ball 217 and the support and axial compression of sealing member 320 facilitate operation with fluid systems. When ball 217 is retained in receiving chamber 380 between supporting member 330 and angled face 384, it deflects inner radial surface 332 of supporting member 330 laterally toward inner radial surface 342 of retaining ring 340 and radially compressing and sealing with sealing member 320. Furthermore, the axial compression of sealing member 320 between supporting member 330 and wall 385 would increase the radial thickness of sealing member 320 between outer radial surface 321 and inner radial surface 322 were it not for the fact that sealing member 320 is radially compressed by ball 217 and inner radial surface 386 of body 317. Instead, the quality of the seal formed with sealing member 320 is further increased. Moreover, since the axial compression and support provided by supporting member 330 to sealing member 320 is uniform over a substantially complete circumference, sealing member 320 can provide a uniform seal over the entirety of outer radial surface 321 and inner radial surface 322.

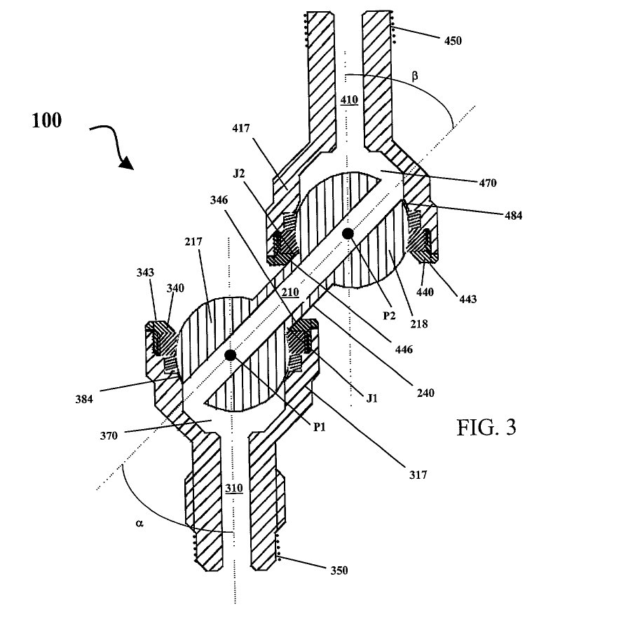

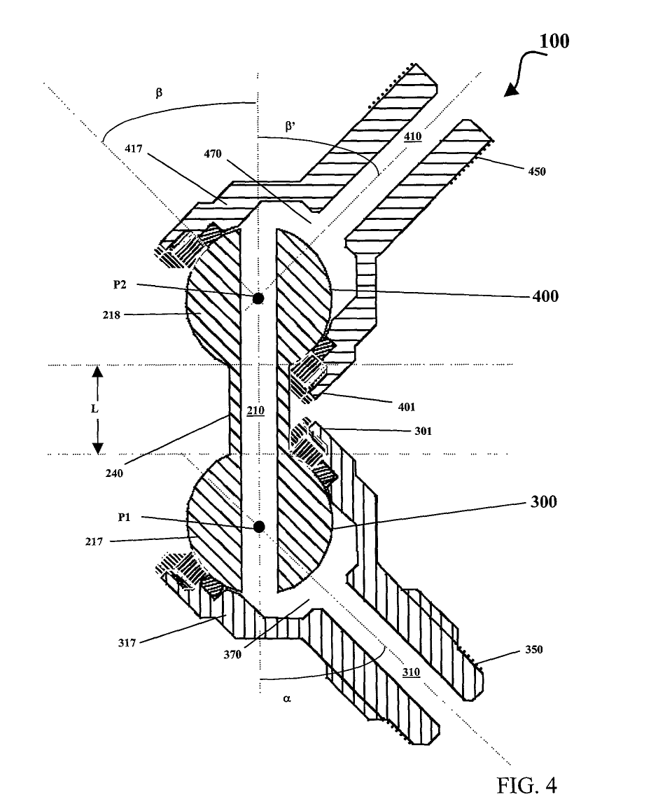

Referring to FIGS. 3 and 4, a flexible joint assembly 100 in various positions is illustrated.

Referring in particular to FIG. 3, a flexible joint assembly 100 in an offset position allows fluid flow between sockets 317, 417 when they are offset. In the illustrated section, the central axes of channels 210, 310, and 410 are all in a plane. Angled faces 384, 484 prevent balls 217, 218 from entering prechambers 370, 470 and sealing off channel 210 when the assembly is not pressurized. When pressurized, a continuous, uninterrupted fluid flow path through channels 210, 310 and 410 of flexible joint assembly 100 is achieved.

In particular, each of fittings 350, 450 can be connected to a fluid flow line or a coupling or other device. A flowing fluid can enter channel 310 and proceed through prechamber 370, make a turn of α degrees into channel 210, pass through prechamber 470, and make an β degree turn in the opposite direction out channel 410. If α is equal to β, the fluid flow path is in the same direction but offset in position by an amount that is proportional to the length of fluid conductor 200 and the sine of angle α. It is preferred that the maximum of each of α and β independently be greater than 30°, greater than 40°, greater than 44°, or equal to 45°. The maximum α and β are determined, in part, by the extent that socket 317 and retaining ring 340 extend to the contact point between central portion 240 and angled face 346. Lateral face 343 can extend, for example, less than 40% of the diameter of ball 217 centrally past the pivot point P1 of ball 217, less than 35% of the diameter of ball 217, or less than 30% of the diameter of ball 217. Lateral face 343 can extend, for example, 29% of the diameter of ball 217 centrally past the pivot point P1 of ball 217.

Since angled faces 346, 446 limit the central extension of retaining rings 340, 440 near central portion 240, central portion 240 can rotate through a relatively large arc within sockets 317, 417. The central extension of retaining rings 340, 440 are thus to be taken at the contact point between central portion 240 and angled faces 346, 446. In other words, angled faces 346, 446 allow contact between central portion 240 and angled faces 346, 446 to occur at relatively large angles α, β, allowing for relatively larger offsets to be achieved.

Contact between central portion 240 and angled faces 346, 446 at the maximum α occurs approximately at junction J1 of ball 217 and central portion 240 and junction J2 of ball 218 and central portion 240. This allows central portion 240 to swivel through a relatively large arc within sockets 317, 417. Contact between central portion 240 and angled faces 346, 446 occurs at a position that less than 75% of the diameter of ball 217 distant from pivots P1, P2, less than 70%, or less than 65%, to form an assembly small in size having maximum flexibility. Alternatively, central portion 240 can be long to provide a large offset in the positions of channels 310, 410. Contact between central portion 240 and angled faces 346, 446 can occur, for example, at a position 62.4% of the diameter of balls 217, 317 distant from a respective pivot P1, P2.

Referring to FIG. 4, a flexible joint assembly 100 in a bent position provides a relatively large angular displacement in the direction of fluid flow between sockets 317, 417. In the illustrated section, the central axes of channels 210, 310, and 410 are all in a plane, and the relative positions of socket 317 and central member 240 are unchanged from FIG. 3, whereas socket 318 has pivoted as discussed below.

Each of fittings 350, 450 can be connected to a fluid flow line or a coupling or other device. A flowing fluid can then enter channel 310 and proceed through prechamber 370, make a turn of α degrees into channel 210, pass through prechamber 470, and make an β′ degree turn in the same direction out channel 410. The net change in the angular displacement in the direction of fluid flow between sockets 317, 417 is equal to the sum of angles α and β′. Angle β can equal angle β′. It is preferred that the maximum sum of α and β′ be greater X than 60°, greater than 80°, and greater than 88°, or equal to 90°. It is therefore possible to achieve relatively large net angular bends in the fluid flow path through joint assembly 100.

Retaining rings 340, 440 are dimensioned to maximize the filly bent position of joint assembly 100. Outer surfaces 301, 401 of sockets 317, 417 have a diameter less than 141% of the length L of central portion 240 between balls 217, 218. Outer surfaces 301, 401 of sockets 317, 318 can be 137% of the length of central portion 240 between balls 217, 218 in diameter. This allows the sum of α and β′ to be 90° without outer surfaces 301, 401 contacting one another and preventing flexure of joint assembly 100.

Referring to FIG. 4, in moving from the offset to the bent position, socket 318 has pivoted through an arc that spans an angle equal to the sum of β and β′ while maintaining a continuous flow path that can operate with pressurized fluids. Alternatively, channel 310 is rotated out of the plane by 180°. Ball and socket joint 400 can be free to swivel through a greater than or equal to 60° arc, through a greater than or equal to 80° arc, through a greater than or equal to 88° arc, or through an arc that is greater than or equal to 90°.

Exemplary dimensions of a flexible joint assembly 100 are as follows: central portion 240 can be 0.747 cm (0.294 inches) long between balls 217, 218; balls 217, 218 can be 1.27 cm (0.5 inches) in diameter; lateral surface 333 of supporting member 330 can be 0.244 cm (0.096 inches) away from pivot P1; and pivots P1 and P2 can be 1.905 cm (0.75 inches) apart. Other exemplary dimensions can be deduced from other portions of this written description.

Sealing member 320 can be an O-ring made from, for example, a molded nitrile rubber, an ethylene propylene rubber, VITON, NEOPRENE, a fluorosilicone, or a silicone elastomer or mixtures thereof. Supporting member 330 can be a split ring made from, for example, molded hard plastics such as TEFLON, HDPE, and acetal. Sockets 317, 318, central member 200, and retaining ring 340 can be made from, for example, cast, sintered, or machined copper, steel, brass, stainless steel, or hard plastics.

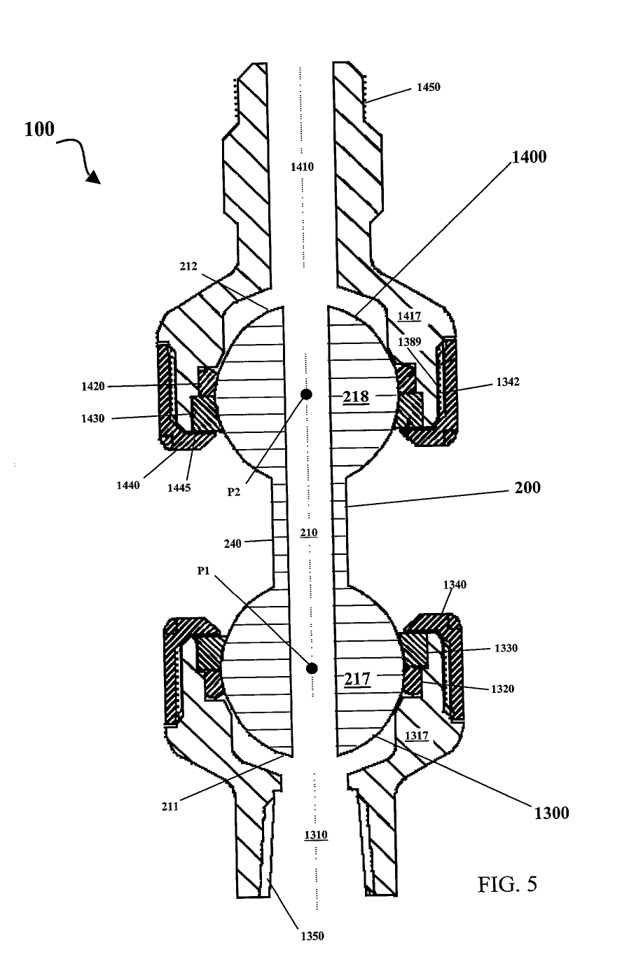

Referring to FIG. 5, flexible joint assembly 100 includes a fluid conductor 200, a first ball and socket joint 1300, and a second ball and socket joint 1400. Balls 217, 218 each form the respective of ball and socket joints 1300, 1400 in conjunction with a respective of sockets 1317, 1417, sealing members 1320, 1420, support members 1330, 1430, and retaining rings 1340, 1440. Sockets 1317, 1417 each define a respective channel 1310, 1410. First and second ball and socket joints 1300, 1400 seal the juncture of channels 1310, 1410 with channel 210, and allow for swiveling about respective pivot points P1, P2 at the center of balls 217, 218.

Referring to one end of joint assembly 100, ball 217 is sealed in socket 1317 by sealing member 1320 and supporting member 1330. Retaining ring 1340 has a threaded inner radial surface 1342 that is dimensioned to threadedly mate with exteriorly threaded wall 1389 of socket 1317 and an inwardly extending pointed lip 1345 that extends radially inward to retain sealing member 1320 within socket 1317. By mating retaining ring 1340 with socket 1317 at the exterior of socket 1317, a relatively larger contact area between threaded mating surfaces can be obtained. This increases the number of threads in the contact area, and hence increases the strength of the mating and the differential pressures that can be accommodated.

Although the figures all illustrate the central axes in a single plane, the sockets can naturally be swiveled out of a single plane. The support member can be two half rings with the same radii. Ball and socket joints can be swivel sockets. A valve can open automatically upon mating of the service device with a service port. The arrangement of the valve and joint assembly along the service line can be changed. The joint assembly can act as a bulkhead connection on the fluid chamber. Fluid can be pumped into the fluid system. The relative orientation of the balls and sockets can also be inverted.

Other embodiments are within the scope of the following claims.

What is claimed is:

1. A flexible joint assembly for conducting a fluid, comprising:
a joint assembly inlet;
a joint assembly outlet; and
a fluid flow path between the inlet and the outlet, the fluid flow path including:
a first pivot joint;
a second pivot joint; and
a central fluid conductor fluidly coupling the pivot joints,
wherein the pivot joints together provide greater than a 60° bend between the inlet and the outlet.

2. The flexible joint assembly of claim 1 wherein each of the first pivot joint and second pivot joint independently comprises a ball and socket joint.

3. The flexible joint assembly of claim 2 wherein each ball and socket joint comprises:
a socket;
a ball received in the socket; and
a seal between the ball to the socket.

4. The flexible joint assembly of claim 3 wherein each ball and socket joint further comprises a compressing member axially compressing the seal between the ball and the socket.

5. The flexible joint assembly of claim 4 wherein each compressing member comprises a retaining ring compressing the seal between the ball and the socket.

6. The flexible joint assembly of claim 1 wherein the central fluid conductor couples to a first ball of the first pivot joint and a second ball of the second pivot joint.

7. The flexible joint assembly of claim 1 wherein the first pivot joint and the second pivot joint together provide a substantially 90° bend between the inlet and the outlet.

8. The flexible joint assembly of claim 1 wherein the central fluid conductor is unitary.

9. The flexible joint assembly of claim 1 wherein the central fluid conductor is shorter than 10 centimeters.

10. The flexible joint assembly of claim 1 wherein the joint assembly inlet and the joint assembly outlet include a fitting.

11. The flexible joint assembly of claim 1 wherein each pivot joint independently provides greater than a 35° bend in the fluid flow path.

12. The flexible joint assembly of claim 1 wherein each pivot joint independently provides greater than a 40° bend in the fluid flow path.

13. A flexible joint assembly comprising:
a joint assembly inlet;
a joint assembly outlet; and
a fluid flow path between the inlet and the outlet, the flow path including:
a first pivot joint;
a second pivot joint; and
a central fluid conductor fluidly coupling the pivot joints, each of the first pivot joint and second pivot joint including:
an inner member;
a receiving member dimensioned to pivotally receive at least part of the inner member;
a sealing member sealing between the inner member and the receiving member; and
a supporting member supporting the sealing member substantially uniformly over the entire length of the seal between the inner member and the receiving member.

14. The flexible joint assembly of claim 13 wherein each sealing member comprises an annular seal having a first surface.

15. The flexible joint assembly of claim 14 wherein each supporting member comprises an annular support having a second surface configured to mate with the first surface of the annular seal thereby supporting the annular seal substantially uniformly.

16. The flexible joint assembly of claim 13 wherein:
each receiving member comprises a first engagement surface; and
each supporting member comprises a second engagement surface, wherein
the first engagement surface is configured to engage the second engagement surface to maintain a fixed relative position between the receiving member and the supporting member.

17. The flexible joint assembly of claim 16 wherein the first engagement surface includes threads dimensioned to engage with threads on the second engagement surface.

18. The flexible joint assembly of claim 13 wherein each sealing member comprises an elastomeric material.

19. The flexible joint assembly of claim 13 wherein:
each inner member comprises a ball;
each receiving member comprises a socket; and
each sealing member comprises an O-ring sealing the ball to the socket.

20. The flexible joint assembly of claim 19 wherein the O-ring has an inner diameter greater than 90% of the diameter of the ball.

21. A flexible joint assembly comprising:
a joint assembly inlet;
a joint assembly outlet; and
a fluid flow path between the inlet and the outlet, the fluid flow path including:
a first pivot joint configured to pivot about a first pivot P1;
a second pivot joint configured to pivot about a second pivot P2; and
a central fluid conductor fluidly coupling the first pivot joint and the second pivot joint, each of the first pivot joint and the second pivot joint including:
an inner member having a dimension D in a direction substantially normal to a path through the respective of the joint assembly inlet and outlet;
a receiving member dimensioned to receive at least part of the inner member; and
a sealing member sealing the inner member to the receiving member at a distance of less than 14% of the dimension D from the respective pivot.

22. The flexible joint assembly of claim 21 wherein:
the first pivot P1 is a pivot point;
the second pivot P2 is a pivot point.

23. A flexible joint assembly comprising:
a joint assembly inlet;
a joint assembly outlet; and
a fluid flow path between the inlet and the outlet, the fluid flow path including:
a first pivot joint configured to pivot over a first arc about a first pivot P1;
a second pivot joint configured to pivot over a second arc about a second pivot P2; and
a central fluid conductor fluidly coupling the pivot joints, each of the first pivot joint and second pivot joint including:
a received joint member having a dimension D in a direction substantially normal to a path through the respective of the joint assembly inlet and outlet; and
a receiving joint member dimensioned to pivotally receive at least part of the received joint member, wherein:
either the received joint member is coupled to one of the joint assembly inlet and the joint assembly outlet and the receiving joint member is coupled to the central fluid conductor, or the receiving joint member is coupled to one of the joint assembly inlet and the joint assembly outlet and the received joint member is coupled to the central fluid conductor; and
a contact point between each receiving joint member and the central fluid conductor whereby the pivot joint is fully pivoted over the respective arc being within 75% of the dimension D distant from the respective pivot.

24. The flexible joint assembly of claim 23 wherein each receiving joint member extends less than 35% of the dimension D beyond the respective pivot.

25. The flexible joint assembly of claim 24 wherein each receiving joint member extends less than 30% of the dimension D centrally beyond the respective pivot.

26. The flexible joint assembly of claim 23 wherein each of the first pivot P1 and the second pivot P2 is a pivot point.

27. The flexible joint assembly of claim 23 wherein each receiving joint member:
is coupled to one of the joint assembly inlet and the joint assembly outlet; and
defines a chamber in communication with the central fluid conductor, the chamber being dimensioned to subsume an at least 115° arc about the respective pivot.

28. A flexible joint assembly comprising:
a first ball and socket joint;
a second ball and socket joint; and
a unitary central fluid conductor connecting the first ball and socket joint and the second ball and socket joint, wherein the assembly is configured to withstand pressures between about 200 and 5000 PSI.

29. The flexible joint assembly of claim 28 wherein each of the first ball and socket joint and second ball and socket joint comprises:
a sealing member between the ball and the socket; and
a supporting member contacting the sealing member substantially uniformly over the entire length of the seal between the ball and the socket.

30. A method of servicing a fluid system comprising:
connecting a service device with a service port of the fluid system, the service device including a flexible joint assembly including a pair of ball and socket joints connected by a fluid conductor; and
transporting a fluid pressurized to between 200 and 5000 PSI through the service device.

31. The method of claim 30 wherein the fluid is a refrigerant.

32. The method according to claim 30 wherein the flexible joint assembly is configured to bend through an angle of up to 90°.

33. The method according to claim 30 wherein the fluid is pressurized to above 300 PSI.

34. The method according to claim 30 wherein:
each of the ball and socket joints includes
a ball having a diameter D and pivoting about a pivot point, and
a retaining ring retaining the ball in the ball and socket joint; and
the fluid conductor includes each ball connected by a pipe member.

35. The method according to claim 30 wherein the fluid system comprises a climate control system.

36. A method of servicing a fluid system comprising:
connecting a service device with a service port of the fluid system, the service device including a flexible joint assembly including a pair of flexible joints connected by a fluid conductor and configured to bend through an angle greater than 60°; and
transporting a fluid through the service device.

37. The method according to claim 36 wherein the flexible joint assembly is configured to bend through an angle greater than 80°.

38. The method according to claim 36 wherein the flexible joint assembly is configured to bend through an angle greater than 88°.

39. The method according to claim 36 wherein the fluid system comprises a climate control system.

40. The method according to claim 36 wherein the fluid comprises a refrigerant.
